(19) United States
(12) Patent Application Publication
(10) Pub. No.: US 2015/0315480 A1
(43) Pub. Date: Nov. 5, 2015

(54) METHOD AND SYSTEM OF UPGRADING HEAVY OILS IN THE PRESENCE OF HYDROGEN AND A DISPERSED CATALYST

(71) Applicants: Patrick Loring Hanks, Bridgewater, NJ (US); Michel DAAGE, Hellertown, PA (US); Thomas Francis DEGNAN, JR., Philadelphia, PA (US); Randolph J. SMILEY, Hellertown, PA (US)

(72) Inventors: Patrick Loring Hanks, Bridgewater, NJ (US); Michel DAAGE, Hellertown, PA (US); Thomas Francis DEGNAN, JR., Philadelphia, PA (US); Randolph J. SMILEY, Hellertown, PA (US)

(73) Assignee: ExxonMobil Research and Engineering Company, Annandale, NJ (US)

(21) Appl. No.: 14/692,069

(22) Filed: Apr. 21, 2015

Related U.S. Application Data
(60) Provisional application No. 61/986,921, filed on May 1, 2014.

(51) Int. Cl. C10G 1/06; C10G 1/00; C01B 3/02; B01J 19/24

(52) U.S. Cl. CPC C10G 1/06; B01J 19/245; C10G 1/002; C01B 3/02; B01J 2219/24

(57) ABSTRACT

Methods and systems are provided for pretreating a heavy oil feed to a hydrocracker, such as a slurry hydrocracker to partially convert the stream and/or to convert catalyst precursors in the stream to catalytically active particles by hydrodynamic cavitation.

### CROSS-REFERENCE TO RELATED APPLICATION

The present application claims priority to U.S. Patent Application Ser. No. 61/986,921, filed May 1, 2014.

### FIELD

This invention relates to a method and system for upgrading heavy oils, and more particularly to methods and systems of upgrading heavy oils in the presence of hydrogen and a dispersed catalyst.

### BACKGROUND

Slurry hydrocracking (“Slurry HDC”) is a process that may be used in some cases to upgrade heavy hydrocarbon oils, such as atmospheric resid, vacuum resid, steam cracker tar, visbreaker tar, deasphalted oil, deasphalted rock, vacuum tower bottoms and combinations thereof to more valuable hydrocarbons.

A typical slurry HDC process utilizes heaters to heat a liquid heavy oil feed and recycle hydrogen gas stream before the oil and recycle gas are fed to the bottom of an upflow slurry reactor. Catalyst may be added to the heavy oil to form a slurry before the oil and catalyst are heated. Reactor conditions in the slurry HDC reactor enable most of the products to vaporize and quickly exit the top of the reactor. This allows the heavier components to remain in the reactor for longer residence times. The reactor product is quenched at the outlet to terminate reactions and the product then flows through a series of separators for recovery of light ends, naphtha, diesel, vacuum gas oils and unconverted feed.

Slurry HDC can be capital intensive, as well as having high operating costs, particularly for processing challenging heavy feed oil streams to high liquid yields. Thus, it would be desirable to provide an improved system and method that would allow for smaller or less capital intensive units with reduced operating expenses to be employed for challenging oil feeds.

### SUMMARY

These and other problems are addressed by the present invention which provides methods and systems of pretreating a heavy oil feed to a hydrocracker, such as a slurry hydrocracker to partially convert the stream and/or to convert catalyst precursors in the stream to catalytically active particles by hydrodynamic cavitation.

In one aspect, a method is provided for upgrading a heavy oil. The method includes subjecting a stream of heavy oil to hydrodynamic cavitation to produce a partially converted stream; and hydrocracking hydrocarbons of at least a part of the partially converted stream in the presence of a hydrogen gas and a dispersed catalyst.

In another aspect, a method is provided for upgrading a heavy oil. The method includes introducing a stream of heavy oil into a hydrodynamic cavitation unit; cavitating a stream of heavy oil in the hydrodynamic cavitation unit under conditions to produce a partially converted stream; introducing at least a part of the partially converted stream into a slurry hydrocracking reactor; and converting the partially converted stream by slurry hydrocracking.

In yet another aspect, a system is provided for upgrading a heavy oil. The system includes a heavy oil feed stream; a hydrodynamic cavitation unit receiving the heavy oil feed stream and adapted to convert the heavy oil feedstream to a partially converted stream; and a slurry hydrocracking unit downstream of the hydrodynamic cavitation unit and comprising a slurry reactor, wherein the slurry hydrocracking unit receives at least portion of the partially converted stream.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for upgrading heavy oils in the presence of hydrogen and dispersed catalyst, according to one or more embodiments of the present invention.

FIG. 3 is a flow diagram of a system for upgrading heavy oils in the presence of hydrogen and dispersed catalyst, according to one or more embodiments of the present invention.

### DETAILED DESCRIPTION

As used herein, the term “heavy oil” refers to hydrocarbon oils having a high viscosity or an API gravity of less than 23 degrees. Suitable feeds include, but are not limited to, atmospheric residue (tower bottoms) having a T5 boiling point (the temperature at which 5 wt % of the material boils off at atmospheric pressure) of about 500° F. or more, or 680° F. or more and a T95 boiling point (the temperature at which 95 wt % of the material boils off at atmospheric pressure) of 1500° F. or more and, heavy vacuum gas oil (VGO) having a T5 boiling point of at least 800° F. or more and a T95 boiling point of about 1100° F. or less, and vacuum residue (tower bottoms) having a T5 boiling point of at least 800° F. or more and a T95 of 1500° F. or more. Suitable feeds include an API gravity of no more than 23 degrees, typically no more than 20 degrees or 10 degrees and may include feeds with less than 5 degrees.

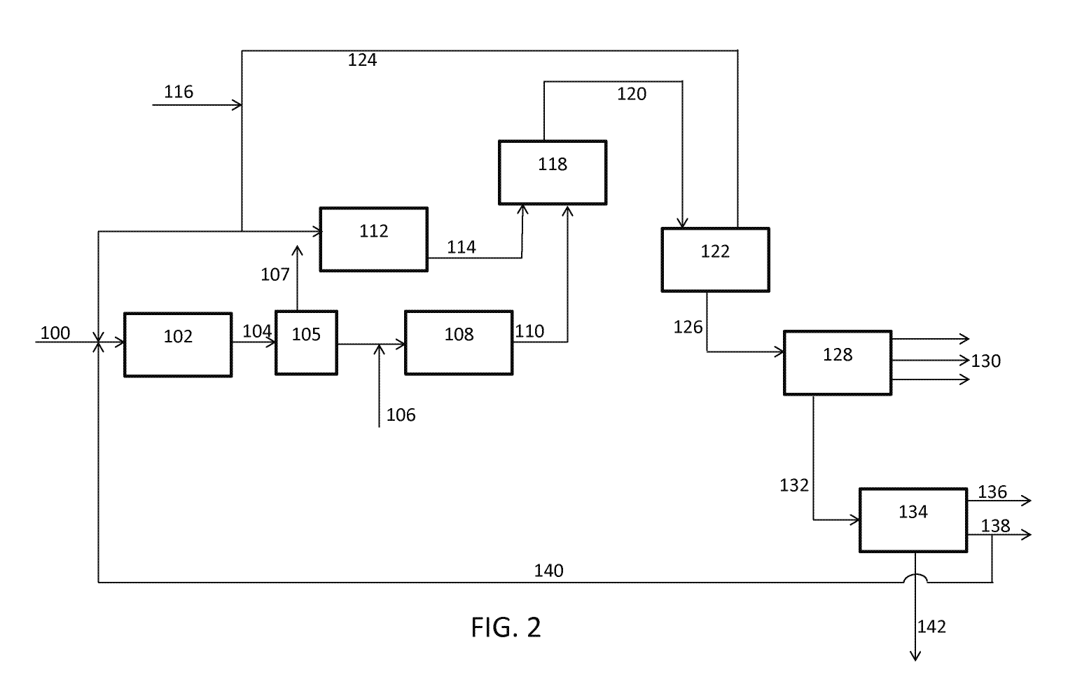

In an exemplary embodiment, as illustrated in FIG. 2, a heavy oil feed 100 may be supplied to hydrodynamic cavitation unit 102 where the stream is subjected to hydrodynamic cavitation to produce a partially converted stream 104. Aspects and operation of the hydrodynamic cavitation unit 102 are described in greater detail subsequently herein. When subjected to hydrodynamic cavitation, a portion of the heavy oil feed 100 is converted to lower molecular weight hydrocarbons. For example, the hydrodynamic cavitation unit 102 may convert between 5 to 50 w % of the heavy oil feed, between 10 to 40 wt % of the heavy oil feed, or between 20 and 35 wt % of the heavy oil feed. Optionally, the effluent if) from the cavitation unit may be fed to a distillation unit or a flash unit 105 to remove the more volatile components 107 prior to introduction into the slurry hydrocracking reactor, and before the stream is contacted with any catalyst or before any hydrogen is added. The more volatile products 107 separated from the effluent may be converted downstream in other units such as a hydrodesulfurization unit or an isomerization unit to upgrade the hydrocarbons to fuel products.

A catalyst feed 106 may deliver catalyst to the partially converted stream 104 to create a partially converted stream of heavy oil with catalyst particles dispersed therein. The partially converted stream 104 may be heated by heater 108 and then fed to the bottom of a slurry hydrocracking reactor 118 along with heated hydrogen stream 114, which is heated by a separate heater 112.

The slurry hydrocracking reactor 118 may be a vertical upflow reactor that receives feed proximal the bottom of the reactor and the effluent, which includes converted product, may be discharged proximal the top of the reactor. In any embodiment, the reactor may operate at 700 to 900° F. (371 to 482° C.) and 1500 to 3100 psi (10.3 to 21.4 MPa). One of the advantages of such a reactor configuration is that the majority of the lighter products are allowed to vaporize and exit the reactor while the heavier products are allowed to remain in the reactor for a longer residence time. This can also serve to minimize undesirable secondary cracking reactions which produce lower-valued products while consuming additional hydrogen.

The slurry hydrocracking reactor 118 may employ any of the known catalysts suitable for imparting hydrogenation activity while limiting the saturation of aromatic rings. In any embodiment, the catalyst can include a catalytically active metal, such as at least one of iron, molybdenum, nickel, and vanadium, as well as sulfides of one or more of these metals. The catalyst is preferably of a size that facilitates dispersion in the heavy oil feed stream. In any embodiment, a non-catalytically active absorbent additive may be used in addition to or in place of the catalyst. The absorbent additive may be any absorbent having an absorbent affinity to asphaltene molecules and may function to absorbently bind to asphaltene molecules and thereby increase the relative residence time of the asphaltene molecules in the reactor. Any additive capable of binding to asphaltene molecules and thereby increasing the residence time of the asphaltene molecules in the reactor may be used including, but not limited to carbonaceous particles, such as coal particles. Such additives may be particularly useful in the Veba Combi Caracker slurry process of Kellogg, Brown and Root, Inc.

The converted products stream 120 is discharged from the slurry hydrocracking reactor 118, where it is fed to a separator unit 122 which separates a hydrogen containing gas stream from the converted products stream 120 and recycles the hydrogen containing gas back to the hydrogen heater 112 with additional make-up hydrogen 116. The separator unit 122 may include a first hot separator, such as a hot flash drum, which separates the heaviest of the converted products stream 120 followed by a cold separator, such as a condenser to separate the hydrogen containing gas from the lighter converted products. The converted product streams (together, represented by stream 126 in FIG. 2) may then be separately fed to the product fractionating unit 128 to separate the fractionated products 130, which may include separate C₄—, naphtha, and diesel fractions.

The bottoms of the product fractionating unit 128 may then be fed a vacuum fractionating unit 134 where a light vacuum gas oil stream 136 and heavy vacuum gas oil stream 138 may be separated from a pitch stream 142. A portion of the heavy vacuum gas oil stream 138 may be recycled and combined with heavy oil feed 100 for reprocessing.

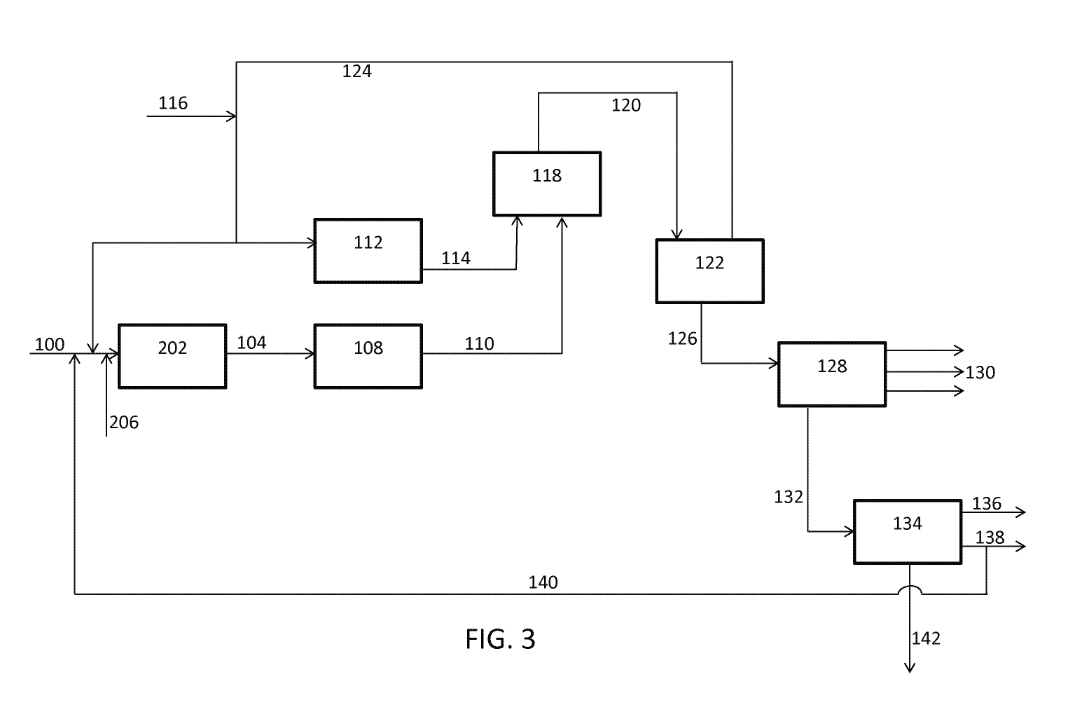

In a related embodiment, as illustrated in FIG. 3, a catalyst feed 206 may inject a catalyst or catalyst precursor into the heavy oil feed stream 100 upstream of a hydrodynamic cavitation unit 202. In such an embodiment, cavitation of the heavy oil feed stream with the dispersed catalyst may allow for greater conversion than would be achieved by cavitation alone by healing radicals and preventing recombination of radical hydrocarbons into larger molecular weight species.

Mixing of hydrogen into heavy oil with dispersed catalyst prior to cavitation may allow for the reduction of olefin content, increase of API, and reduction in viscosity of reversion caused by radicals that remain in the converted product stream after hydrocracking and that survive the subsequent transfer and storage of the products of the process. Furthermore, it is believed that the healing of radicals (or “radical capping”) may allow for higher conversions than achieved in slurry hydrocracking processes.

In an embodiment in which catalyst precursors are injected into the heavy oil feed stream 100 upstream of the hydrodynamic cavitation unit 202, several advantages may be realized including advantages associated with omitting convention catalyst generation processes. For example, the slurry hydrocracking system may occupy a smaller footprint, overall capital costs for the system may be reduced, and quicker catalyst generation may be achieved.

Various catalyst precursors may be used in such a process including molybdenum-containing compounds, such as phosphomolybdic acid, moly-octanoate or moly-naphthenate. When such compounds are dispersed in heavy oil and cavitated, molybdenum-containing carbon solids with sufficient activity as the slurry catalyst in the slurry hydrocracking reactor 118.

### Feedstocks

In some aspects, a wide range of petroleum and chemical feedstocks can be hydroprocessed and/or slurry hydroprocessed in accordance with the invention. Suitable feedstocks include but are not limited to: whole and reduced petroleum crudes, atmospheric and vacuum residua, propane deasphalted residua, e.g., brightstock, cycle oils, FCC tower bottoms, gas oils, including vacuum gas oils and coker gas oils, light to heavy distillates including raw virgin distillates, hydrocrackates, hydrotreated oils, slack waxes, Fischer-Tropsch waxes, raffinates, and mixtures of these materials.

One way of defining a feedstock is based on the boiling range of the feed. One option for defining a boiling range is to use an initial boiling point for a feed and/or a final boiling point for a feed. Another option, which in some instances may provide a more representative description of a feed, is to characterize a feed based on the amount of the feed that boils at one or more temperatures. For example, a “T5” boiling point for a feed is defined as the temperature at which 5 wt % of the feed will boil off. Similarly, a “T95” boiling point is a temperature at 95 wt % of the feed will boil.

Typical feeds include, for example, feeds with an initial boiling point of at least about 650° F. (343° C.), or at least about 700° F. (371° C.), or at least about 750° F. (399° C.). Alternatively, a feed may be characterized using a T5 boiling point, such as a feed with a T5 boiling point of at least about 650° F. (343° C.), or at least about 700° F. (371° C.), or at least about 750° F. (399° C.). In some aspects, the final boiling point of the feed can be at least about 1100° F. (593° C.), such as at least about 1150° F. (621° C.) or at least about 1200° F. (649° C.). In other aspects, a feed may be used that does not include a large portion of molecules that would traditional be considered as vacuum distillation bottoms. For example, the feed may correspond to a vacuum gas oil feed that has already been separated from a traditional vacuum bottoms portion. Such feeds include, for example, feeds with a final boiling point of about 1150° F. (621° C.), or about 1100° F. (593° C.) or less, or about 1050° F. (566° C.) or less. Alternatively, a feed may be characterized using a T95 boiling point, such as a feed with a T95 boiling point of about 1150° F. (621° C.) or less, or about 1100° F. (593° C.) or less, or about 1050° F. (566° C.) or less. An example of a suitable type of feedstock is a wide cut vacuum gas oil (VGO) feed, with a T5 boiling point of at least about 700° F. (371° C.) and a T95 boiling point of about 1100° F. or less. Optionally, the initial boiling point of such a wide cut VGO feed can be at least about 700° F. and/or the final boiling point can be at least about 1100° F. it is noted that feeds with still lower initial boiling points and/or T5 boiling points may also be suitable, so long as sufficient higher boiling material is available so that the overall nature of the process is a lubricant base oil production process and/or a fuels hydrocracking process.

The above feed description corresponds to a potential feed for producing lubricant base oils, in some aspects, methods are provided for producing both fuels and lubricants. Because fuels are a desired product, feedstocks with lower boiling components may also be suitable. For example, a feedstock suitable for fuels production, such as a light cycle oil, can have a T5 boiling point of at least about 350° F. (177° C.), such as at least about 400° F. (204° C.). Examples of a suitable boiling range include a boiling range of from about 350° F. (177° C.) to about 700° F. (371° C.), such as from about 390° F. (200° C.) to about 650° F. (343° C.). Thus, a portion of the feed used for fuels and lubricant base oil production can include components having a boiling range from about 170° C. to about 350° C. Such components can be part of an initial feed, or a first feed with a T5 boiling point of about 650° F. (343° C.) can be combined with a second feed, such as a light cycle oil, that includes components that boil between 200° C. and 350° C.

In embodiments involving an initial sulfur removal stage prior to hydrocracking, the sulfur content of the feed can be at least 300 ppm by weight of sulfur, or at least 1000 wppm, or at least 2000 wppm, or at least 4000 wppm, or at least 10,000 wppm, or at least about 20,000 wppm. In other embodiments, including some embodiments where a previously hydrotreated and/or hydrocracked feed is used, the sulfur content can be about 2000 wppm or less, or about 1000 wppm or less, or about 500 wppm or less, or about 100 wppm or less.

In some aspects, a slurry hydroprocessed product and/or intermediate products can also be produced from a heavy oil feed component. Examples of heavy oils include, but are not limited to, heavy crude oils, distillation residues, heavy oils coming from catalytic treatment (such as heavy cycle bottom slurry oils from fluid catalytic cracking), thermal tars (such as oils from visbreaking, steam cracking, or similar thermal or non-catalytic processes), oils (such as bitumen) from oil sands and heavy oils derived from coal.

Heavy oil feedstocks (also referred to as heavy oils) can be liquid or semi-solid. Examples of heavy oils that can be hydroprocessed, treated or upgraded according to this invention include bitumens and residuum from refinery distillation processes, including atmospheric and vacuum distillation processes. Such heavy oils can have an initial ASTM D86 boiling point of 650° F. (343° C.) or greater. Preferably, the heavy oils will have an ASTM D86 10% distillation point of at least 650° F. (343° C.), alternatively at least 660° F. (349° C.) or at least 750° F. (399° C.). In some aspects the D86 10% distillation point can be still greater, such as at least 900° F. (482° C.), or at least 950° F. (510° C.), or at least 975° F. (524° C.), or at least 1020° F. (549° C.) or at least 1050° F. (566° C.).

In addition to initial boiling points and/or 10% distillation points, other distillation points may also be useful in characterizing a feedstock. For example, a feedstock can be characterized based on the portion of the feedstock that boils above 1050° F. (566° C.). In some aspects, a feedstock can have an ASTM D86 70% distillation point of 1050° F. or greater, or a 60% distillation point of 1050° F. or greater, or a 50% distillation point of 1050° F. or greater, or a 40% distillation point of 1050° F. or greater.

Density, or weight per volume, of the heavy hydrocarbon can be determined according to ASTM D287-92 (2006) Standard Test Method for API Gravity of Crude Petroleum and Petroleum Products (Hydrometer Method), and is provided in terms of API gravity. In general, the higher the API gravity, the less dense the oil. API gravity is 20° or less in one aspect, 15° or less in another aspect, and 10° or less in another aspect.

Heavy oils can be high in metals. For example, the heavy oil can be high in total nickel, vanadium and iron contents. In one embodiment, the heavy oil will contain at least 0.00005 grams of Ni/V/Fe (50 ppm) or at least 0.0002 grams of Ni/V/Fe (200 ppm) per gram of heavy oil, on a total elemental basis of nickel, vanadium and iron.

Contaminants such as nitrogen and sulfur are typically found in heavy oils, often in organically-bound form. Nitrogen content can range from about 50 wppm to about 10,000 wppm elemental nitrogen or more, based on total weight of the heavy hydrocarbon component. The nitrogen containing compounds can be present as basic or non-basic nitrogen species. Examples of basic nitrogen species include quinolines and substituted quinolines. Examples of non-basic nitrogen species include carbazoles and substituted carbazoles.

Slurry hydroconversion can be used for treating heavy oils containing at least 500 wppm elemental sulfur, based on total weight of the heavy oil. Generally, the sulfur content of such heavy oils can range from about 500 wppm to about 100,000 wppm elemental sulfur, or from about 1000 wppm to about 50,000 wppm, or from about 1000 wppm to about 30,000 wppm, based on total weight of the heavy component. Sulfur will usually be present as organically bound sulfur. Examples of such sulfur compounds include the class of heterocyclic sulfur compounds such as thiophenes, tetrahydrothiophenes, benzothiophenes and their higher homologs and analogs. Other organically bound sulfur compounds include aliphatic, naphthenic, and aromatic mercaptans, sulfides, and di- and polysulfides.

Heavy oils can be high in n-pentane asphaltenes. In some aspects, the heavy oil can contain at least about 5 wt % of n-pentane asphaltenes, such as at least about 10 wt % or at least 15 wt % n-pentane asphaltenes.

Still another method for characterizing a heavy oil feedstock is based on the Conradson carbon residue of the feedstock. The Conradson carbon residue of the feedstock can be at least about 5 wt %, such as at least about 10 wt % or at least about 20 wt %. Additionally or alternately, the Conradson carbon residue of the feedstock can be about 50 wt % or less, such as about 40 wt % or less or about 30 wt % or less.

In various aspects of the invention, reference may be made to one or more types of fractions generated during distillation of a petroleum feedstock. Such fractions may include naphtha fractions, kerosene fractions, diesel fractions, and vacuum gas oil fractions. Each of these types of fractions can be defined based on a boiling range, such as a boiling range that includes at least 90 wt % of the fraction, and preferably at least 95 wt % of the fraction. For example, for many types of naphtha fractions, at least 90 wt % of the fraction, and preferably at least 95 wt %, can have a boiling point in the range of 85° F. (29° C.) to 350° F. (177° C.). For some heavier naphtha fractions, at least 90 wt % of the fraction, and preferably at least 95 wt %, can have a boiling point in the range of 85° F. (29° C.) to 400° F. (204° C.). For a kerosene fraction, at least 90 wt % of the fraction, and preferably at least 95 wt %, can have a boiling point in the range of 300° F. (149° C.) to 600° F. (288° C.). Alternatively, for a kerosene fraction targeted for some uses, such as jet fuel production, at least 90 wt % of the fraction, and preferably at least 95 wt %, can have a boiling point in the range of 300° F. (149° C.) to 550° F. (288° C.). For a diesel fraction, at least 90 wt % of the fraction, and preferably at least 95 wt %, can have a boiling point in the range of 400° F. (204° C.) to 750° F. (399° C.).

### Slurry Hydrocracking

In a reaction system, slurry hydroconversion can be performed by processing a feed in one or more slurry hydroconversion reactors. The reaction conditions in a slurry hydroconversion reactor can vary based on the nature of the catalyst, the nature of the feed, the desired products, and/or the desired amount of conversion.

With regard to catalyst, suitable catalyst concentrations can range from about 50 wppm to about 30,000 wppm (or about 3 wt %), depending on the nature of the catalyst. Catalyst can be incorporated into a hydrocarbon feedstock directly, or the catalyst can be incorporated into a side or slip stream of feed and then combined with the main flow of feedstock. Still another option is to form catalyst in-situ by introducing a catalyst precursor into a feed (or a side/slip stream of feed) and forming catalyst by a subsequent reaction.

Catalytically active metals for use in hydroprocessing can include those from Group IVB, Group VB, Group VIB, Group VIM, or Group VIII of the Periodic Table. Examples of suitable metals include iron, nickel, molybdenum, vanadium, tungsten, cobalt, ruthenium, and mixtures thereof. The catalytically active metal may be present as a solid particulate in elemental form or as an organic compound or an inorganic compound such as a sulfide (e.g., iron sulfide) or other ionic compound. Metal or metal compound nanoaggregates may also be used to form the solid particulates.

A catalyst in the form of a solid particulate is generally a compound of a catalytically active metal, or a metal in elemental form, either alone or supported on a refractory material such as an inorganic metal oxide (e.g., alumina, silica, titania, zirconia, and mixtures thereof). Other suitable refractory materials can include carbon, coal, and clays. Zeolites and non-zeolitic molecular sieves are also useful as solid supports. One advantage of using a support is its ability to act as a “coke getter” or adsorbent of asphaltene precursors that might otherwise lead to fouling of process equipment.

In some aspects, it can be desirable to form catalyst for slurry hydroconversion in situ, such as forming catalyst from a metal sulfate (e.g., iron sulfate monohydrate) catalyst precursor or another type of catalyst precursor that decomposes or reacts in the hydroprocessing reaction zone environment, or in a pretreatment step, to form a desired, well-dispersed and catalytically active solid particulate (e.g., as iron sulfide). Precursors also include oil-soluble organometallic compounds containing the catalytically active metal of interest that thermally decompose to form the solid particulate (e.g., iron sulfide) having catalytic activity. Other suitable precursors include metal oxides that may be converted to catalytically active (or more catalytically active) compounds such as metal sulfides, in a particular embodiment, a metal oxide containing mineral may be used as a precursor of a solid particulate comprising the catalytically active metal (e.g., iron sulfide) on an inorganic refractory metal oxide support (e.g., alumina).

The reaction conditions within a slurry hydroconversion reactor can include a temperature of about 400° C. to about 480° C., such as at least about 425° C., or about 450° C. or less. Some types of slurry hydroconversion reactors are operated under high hydrogen partial pressure conditions, such as having a hydrogen partial pressure of about 1200 psig to about 3400 psig, such as at least 1500 psig or 2000 psig. Since the catalyst is in slurry form within the feedstock, the space velocity for a slurry hydroconversion reactor can be characterized based on the volume of feed processed relative to the volume of the reactor used for processing the feed. Suitable space velocities for slurry hydroconversion can range from about 0.05 v/v/hr⁻¹ to about 5 v/v/h⁻¹ such as about 0.1 v/v/hr⁻¹ to about 2.0 v/v/hr⁻¹. The amount of hydrogen treat gas used for slurry hydroconversion can be up to about 8000 scf/B, such as up to about 10000 scf/B or more.

The reaction conditions for slurry hydroconversion can be selected so that the net conversion of feed across all slurry hydroconversion reactors (if there is more than one arranged in series) is at least about 80%, such as at least about 90%, or at least about 95%. For slurry hydroconversion, conversion is defined as conversion of compounds with boiling points greater than a conversion temperature, such as 975° F. (524° C.), to compounds with boiling points below the conversion temperature. The portion of a heavy feed that is unconverted after slurry hydroconversion can be referred to as pitch or a bottoms fraction from the slurry hydroconversion.

### Hydrocracking Conditions

In various aspects, the reaction conditions in the reaction system can be selected to generate a desired level of conversion of a feed. Conversion of the feed can be defined in terms of conversion of molecules that boil above a temperature threshold to molecules below that threshold. The conversion temperature can be any convenient temperature, such as about 700° F. (371° C.). In an aspect, the amount of conversion in the stage(s) of the reaction system can be selected to enhance diesel production while achieving a substantial overall yield of fuels. The amount of conversion can correspond to the total conversion of molecules within any stage of the fuels hydrocracker or other reaction system that is used to hydroprocess the lower boiling portion of the feed from the vacuum distillation unit. Suitable amounts of conversion of molecules boiling above 700° F. to molecules boiling below 700° F. include converting at least 10% of the 700° F.+ portion of the feedstock to the stage(s) of the reaction system, such as at least 20% of the 700° F.+ portion, or at least 30%. Additionally or alternately, the amount of conversion for the reaction system can be about 85% or less, or about 70% or less, or about 55% or less, or about 40% or less. Still larger amounts of conversion may also produce a suitable hydrocracker bottoms for forming lubricant base oils, but such higher conversion amounts will also result in a reduced yield of lubricant base oils. Reducing the amount of conversion can increase the yield of lubricant base oils, but reducing the amount of conversion to below the ranges noted above may result in hydrocracker bottoms that are not suitable for formation of Group II, Group II+, or Group III lubricant base oils.

In order to achieve a desired level of conversion, a reaction system can include at least one hydrocracking catalyst. Hydrocracking catalysts typically contain sulfided base metals on acidic supports, such as amorphous silica alumina, cracking zeolites such as USY, or acidified alumina. Often these acidic supports are mixed or bound with other metal oxides such as alumina, titania or silica. Examples of suitable acidic supports include acidic molecular sieves, such as zeolites or silicoaluminophophates. One example of suitable zeolite is USY, such as a USY zeolite with cell size of 24.30 Angstroms or less. Additionally or alternately, the catalyst can be a low acidity molecular sieve, such as a USY zeolite with a Si to Al ratio of at least about 20, and preferably at least about 40 or 50. ZSM-48, such as ZSM-48 with a SiO₂ to Al₂O₃ ratio of about 110 or less, such as about 90 or less, is another example of a potentially suitable hydrocracking catalyst. Still another option is to use a combination of USY and ZSM-48. Still other options include using one or more of zeolite Beta, ZSM-5, ZSM-35, or ZSM-23, either alone or in combination with a USY catalyst. Non-limiting examples of metals for hydrocracking catalysts include metals or combinations of metals that include at least one Group VIII metal, such as nickel, nickel-cobalt-molybdenum, cobalt-molybdenum, nickel-tungsten, nickel-molybdenum, and/or nickel-molybdenum-tungsten. Additionally or alternately, hydrocracking catalysts with noble metals can also be used. Non-limiting examples of noble metal catalysts include those based on platinum and/or palladium. Support materials which may be used for both the noble and non-noble metal catalysts can comprise a refractory oxide material such as alumina, silica, alumina-silica, kieselguhr, diatomaceous earth, magnesia, zirconia, or combinations thereof, with alumina, silica, alumina-silica being the most common (and preferred, in one embodiment).

In various aspects, the conditions selected for hydrocracking for fuels hydrocracking and/or lubricant base stock production can depend on the desired level of conversion, the level of contaminants in the input feed to the hydrocracking stage, and potentially other factors. For example, hydrocracking conditions in a single stage, or in the first stage and/or the second stage of a multi-stage system, can be selected to achieve a desired level of conversion in the reaction system. Hydrocracking conditions can be referred to as sour conditions or sweet conditions, depending on the level of sulfur and/or nitrogen present within a feed. For example, a feed with 100 wppm or less of sulfur and 50 wppm or less of nitrogen, preferably less than 25 wpm sulfur and/or less than 10 wppm of nitrogen, represent a feed for hydrocracking under sweet conditions. Preferably, a slurry hydroconversion effluent that has also been hydrotreated can have a sufficiently low content of sulfur and/or nitrogen for hydrocracking under sweet conditions.

A hydrocracking process under sour conditions can be carried out at temperatures of about 550° F. (288° C.) to about 840° F. (449° C.), hydrogen partial pressures of from about 250 psig to about 5000 psig (1.8 MPag to 34.6 MPag), liquid hourly space velocities of from 0.05 h⁻¹ to 10 h⁻¹, and hydrogen treat gas rates of from 35.6 m³/m³ to 1781 m³/m³ (200 SCF/B to 10,000 SCF/B). In other embodiments, the conditions can include temperatures in the range of about 600° F. (343° C.) to about 815° F. (435° C.), hydrogen partial pressures of from about 500 psig to about 3000 psig (3.5 MPag-20.9 MPag), and hydrogen treat gas rates of from about 213 m³/m³ to about 1068 m³/m³ (1200 SCF/B to 6000 SCF/B). The LHSV relative to only the hydrocracking catalyst can be from about 0.25 h⁻¹ to about 50 h⁻¹, such as from about 0.5 h⁻¹ to about 20 h⁻¹, and preferably from about 1.0 h⁻¹ to about 4.0 h⁻¹

In some aspects, a portion of the hydrocracking catalyst and/or the dewaxing catalyst can be contained in a second reactor stage. In such aspects, a first reaction stage of the hydroprocessing reaction system can include one or more hydrotreating and/or hydrocracking catalysts. The conditions in the first reaction stage can be suitable for reducing the sulfur and/or nitrogen content of the feedstock. A separator can then be used in between the first and second stages of the reaction system to remove gas phase sulfur and nitrogen contaminants. One option for the separator is to simply perform a gas-liquid separation to remove contaminant. Another option is to use a separator such as a flash separator that can perform a separation at a higher temperature. Such a high temperature separator can be used, for example, to separate the feed into a portion boiling below a temperature cut point, such as about 350° F.′ (177° C.) or about 400° F. (204° C.), and a portion boiling above the temperature cut point. In this type of separation, the naphtha boiling range portion of the effluent from the first reaction stage can also be removed, thus reducing the volume of effluent that is processed in the second or other subsequent stages. Of course, any low boiling contaminants in the effluent from the first stage would also be separated into the portion boiling below the temperature cut point. If sufficient contaminant removal is performed in the first stage, the second stage can be operated as a “sweet” or low contaminant stage.

Still another option can be to use a separator between the first and second stages of the hydroprocessing reaction system that can also perform at least a partial fractionation of the effluent from the first stage. In this type of aspect, the effluent from the first hydroprocessing stage can be separated into at least a portion boiling below the distillate (such as diesel) fuel range, a portion boiling in the distillate fuel range, and a portion boiling above the distillate fuel range. The distillate fuel range can be defined based on a conventional diesel boiling range, such as having a lower end cut point temperature of at least about 350° F. (177° C.) or at least about 400° F. (204° C.) to having an upper end cut point temperature of about 700° F. (371° C.) or less or 650° F. (343° C.) or less. Optionally, the distillate fuel range can be extended to include additional kerosene, such as by selecting a lower end cut point temperature of at least about 300° F. (149° C.).

In aspects where the inter-stage separator is also used to produce a distillate fuel fraction, the portion boiling below the distillate fuel fraction includes, naphtha boiling range molecules, light ends, and contaminants such as H₂S. These different products can be separated from each other in any convenient manner. Similarly, one or more distillate fuel fractions can be formed, if desired, from the distillate boiling range fraction. The portion boiling above the distillate fuel range represents the potential lubricant base oils. In such aspects, the portion boiling above the distillate fuel range is subjected to further hydroprocessing in a second hydroprocessing stage.

A hydrocracking process under sweet conditions can be performed under conditions similar to those used for a sour hydrocracking process, or the conditions can be different. In an embodiment, the conditions in a sweet hydrocracking stage can have less severe conditions than a hydrocracking process in a sour stage. Suitable hydrocracking conditions for a non-sour stage can include, but are not limited to, conditions similar to a first or sour stage. Suitable hydrocracking conditions can include temperatures of about 550° F. (288° C.) to about 840° F. (449° C.), hydrogen partial pressures of from about 250 psig to about 5000 psig (1.8 MPag to 34.6 MPag), liquid hourly space velocities of from 0.05 h⁻¹ to 10 h⁻¹, and hydrogen treat gas rates of from 35.6 m³/m³ to 1781 m³/m³ (200 SCF/B to 10,000 SCF/B). In other embodiments, the conditions can include temperatures in the range of about 600° F. (343° C.) to about 815° F. (435° C.), hydrogen partial pressures of from about 500 psig to about 3000 psig (3.5 MPag-20.9 MPag), and hydrogen treat gas rates of from about 213 m³/m³ to about 1068 m³/m³ (1200 SCF/B to 6000 SCF/B). The liquid hourly space velocity can vary depending on the relative amount of hydrocracking catalyst used versus dewaxing catalyst. Relative to the combined amount of hydrocracking and dewaxing catalyst, the LHSV can be from about 0.2 h⁻¹ to about 10 such as from about 0.5 h⁻¹ to about 5 h⁻¹ and/or from about 1 h⁻¹ to about 4 h⁻¹. Depending on the relative amount of hydrocracking catalyst and dewaxing catalyst used, the LHSV relative to only the hydrocracking catalyst can be from about 0.25 h⁻¹ to about 50 h⁻¹, such as from about 0.5 h⁻¹ to about 20 h⁻¹, and preferably from about 1.0 h⁻¹ to about 4.0 h⁻¹.

In still another embodiment, the same conditions can be used for hydrotreating and hydrocracking beds or stages, such as using hydrotreating conditions for both or using hydrocracking conditions for both. In yet another embodiment, the pressure for the hydrotreating and hydrocracking beds or stages can be the same.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

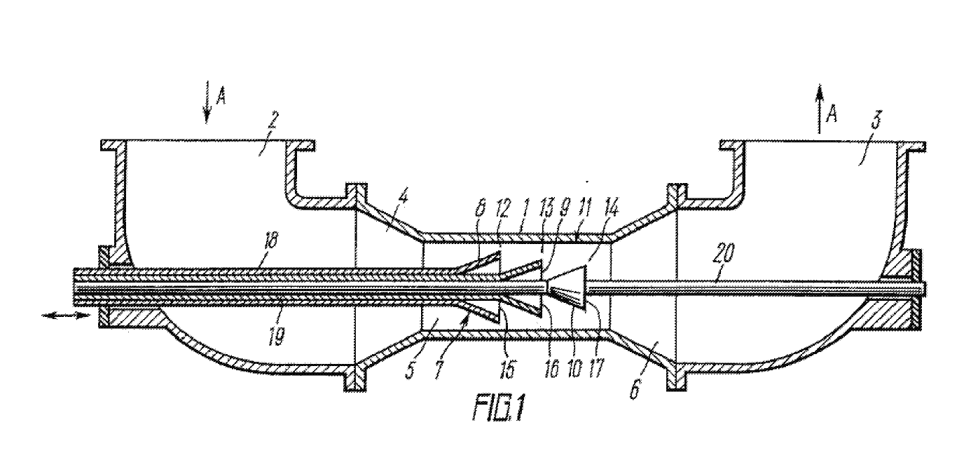

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing I having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,429,654, which is incorporated by reference herein in its entirety. Other designs of hydrodynamic cavitation units are described in the published literature, including but not limited to U.S. Pat. Nos. 5,937,906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a velocity of 10¹⁰-10¹² K/sec. The vaporous/gaseous mixture of hydrocarbons found inside the bubbles may reach temperatures in the range of 1500-15,000K at a pressure of 100-1500 MPa. Under these physical conditions inside of the cavitation bubbles, thermal disintegration of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (ie, thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

### Specific Embodiments

In order to better illustrate aspects of the present invention, the following specific embodiments are provided:

Paragraph A—A method of upgrading a heavy oil comprising: subjecting a stream of heavy oil to hydrodynamic cavitation to produce a partially converted stream; and hydrocracking hydrocarbons of at least a part of the partially converted stream in the presence of a hydrogen containing gas and a dispersed catalyst or absorbent additive.

Paragraph B—A method of upgrading a heavy oil comprising: introducing a stream of heavy oil into a hydrodynamic cavitation unit; cavitating a stream of heavy oil in the hydrodynamic cavitation unit under conditions to produce a partially converted stream; introducing at least a part of the partially converted stream into a slurry hydrocracking reactor; and converting the partially converted stream by slurry hydrocracking.

Paragraph C—The method of any of Paragraphs A-C, further comprising injecting a portion of the hydrogen containing gas into the stream of heavy oil prior to subjecting the stream of heavy oil to hydrodynamic cavitation.

Paragraph D—The method of any of Paragraphs A-C, further comprising injecting a catalyst or absorbent additive into the stream of heavy oil so as to produce a stream of heavy oil with the catalyst or absorbent additive dispersed therein prior to hydrodynamic cavitation.

Paragraph E—The method of any of Paragraphs A-C, further comprising injecting a catalyst precursor into the stream of heavy oil so as to produce a stream of heavy oil with the catalyst precursor dispersed therein prior to hydrodynamic cavitation.

Paragraph F—The method of any of Paragraphs A-E, wherein the heavy oil has an API of less than 20°.

Paragraph G—The method of any of Paragraphs A-F, wherein the heavy oil comprises heavy vacuum gas oil.

Paragraph H—The method of any of Paragraphs A-G, wherein the partially converted stream has a lower viscosity at 50° C. by ASTM D445 than the stream of heavy oil.

Paragraphs I—The method of any of Paragraphs A-H, wherein 5 and 70 weight percent of the stream of oil is converted to lower molecular weight hydrocarbons by the hydrodynamic cavitation.

Paragraph J—The method of any of Paragraphs A-I, wherein a 10% distillation point of the stream of heavy oil is at least about 900° F.

Paragraph K—The method of any of Paragraphs A-J, wherein the heavy oil has a Conradson carbon residue by ASTM D4530 of at least about 27.5 wt %, such as at least about 30 wt %.

Paragraph L—The method of any of Paragraphs A-K, wherein the step of hydrocracking comprises slurry hydrocracking.

Paragraph M—The method of any of Paragraphs A-L, wherein the step of hydrocracking further comprises forming an unconverted slurry hydroconversion pitch.

Paragraph N—The method of any of Paragraphs A-M, wherein the catalyst comprises a molecular sieve selected from USY, ZSM-48, or a combination thereof.

Paragraph O—The method of any of Paragraphs A-N, wherein the heavy oil an initial boiling point of at least about 650° F.

Paragraph P—The method of any of Paragraphs A-O, wherein the stream of heavy oil is subjected to a pressure drop greater than 400 psig, or preferably greater than 1000 psig, or even more preferably greater than 2000 psig during hydrodynamic cavitation.

Paragraph Q—The method of any of Paragraphs A-P, wherein the stream of heavy oil comprises a 1050° F. boiling fraction, and about 1 to about 50 wt % of the 1050+° F. boiling fraction is converted when subjected to hydrodynamic cavitation.

Paragraph R—The method of any of Paragraphs A-C or Paragraphs E-Q, wherein the hydrodynamic cavitation is performed in the absence of a catalyst.

Paragraph S—The method of any of Paragraphs A-R, wherein the hydrodynamic cavitation is performed in the absence of a diluent oil or water.

Paragraph T—The method of any of Paragraphs A-S, further comprising upgrading a product of the hydrocracking by distillation, hydroprocessing, fluidized catalytic cracking, dewaxing, delayed coking, fluid coking, partial oxidation, gasification, deasphalting, or a combination thereof.

Paragraph U—The method of any of Paragraphs A-T, further comprising subjecting the partially converted stream to vapor-liquid separation to separate volatile components from the partially converted stream.

Paragraph V—A system adapted to perform the method of any of Paragraphs A-U.

Paragraph W—A system for upgrading a heavy oil comprising: a heavy oil feed stream; a hydrodynamic cavitation unit receiving the heavy oil feed stream and adapted to convert the heavy oil feedstream to a partially converted stream; and a slurry hydrocracking unit downstream of the hydrodynamic cavitation unit and comprising a slurry reactor, wherein the slurry hydrocracking unit receives at least portion of the partially converted stream.

Paragraph X—The system of Paragraph W adapted to perform the method of any of Paragraphs A-U.

Paragraph Y—The system of Paragraph W or X, further comprising a vapor-liquid separator downstream of the hydrodynamic cavitation unit and upstream of the slurry hydrocracking unit, the vapor-liquid separator adapted to separate volatile components from the partially converted stream.

Paragraph Z—The system of Paragraph Y, wherein the vapor-liquid separator is a distillation unit or a flash unit.

### Example One

In a basic proof of concept test, Athabasca bitumen was premixed with molyoctanoate and cavitated in the presence of small amounts of hydrogen. Solid particles were observed in the cavitation effluent that were not seen when neat Athabasca bitumen was cavitated. The solids from the bitumen-molyoctanoate mixture were isolated using a 0.5 micron filter. The solids retained on the 0.5 micron filter were washed with heptane. The solids were subsequently submitted for metals analysis by inductively coupled plasma atomic emission spectroscopy. The solids were found to contain 3910 ppm by weight molybdenum. Thus, it is expected that catalyst particles can be formed by the hydrodynamic cavitation of molybdenum-containing catalyst precursors in heavy oil.

What is claimed is:

1. A method of upgrading a heavy oil comprising:
subjecting a stream of heavy oil to hydrodynamic cavitation to produce a partially converted stream; and
hydrocracking hydrocarbons of at least a part of the partially converted stream in the presence of a hydrogen containing gas and a dispersed catalyst or absorbent.

2. The method of claim 1, further comprising injecting a portion of the hydrogen containing gas into the stream of heavy oil prior to subjecting the stream of heavy oil to hydrodynamic cavitation.

3. The method of claim 2, wherein the portion of the hydrogen containing gas is provided prior to hydrodynamic cavitation is provided at a rate of 1-500 scf/B.

4. The method of claim 1, further comprising injecting the catalyst or absorbent into the stream of heavy oil so as to produce a stream of heavy oil with the catalyst or absorbent dispersed therein prior to hydrodynamic cavitation.

5. The method of claim 4, wherein the dispersed catalyst is present in the heavy oil at a catalyst concentrations from about 50 wppm to about 30,000 wppm.

6. The method of claim 1, further comprising injecting a catalyst precursor into the stream of heavy oil so as to produce a stream of heavy oil with the catalyst precursor dispersed therein prior to hydrodynamic cavitation.

7. The method of claim 6, wherein the catalyst precursor is selected from the group consisting of a metal sulfate, metal oxides, organometallic compounds that thermally decompose to form solid particulates with catalytic activity, and combinations thereof.

8. The method of claim 6, wherein the catalyst precursor is selected from a group consisting of phosphomolybdic acid, moly-octanoate, moly-naphthenate, iron sulfate monohydrate and combinations thereof.

9. The method of claim 1, wherein the heavy oil has an API of less than 20°.

10. The method of claim 1, wherein the heavy oil comprises heavy vacuum gas oil.

11. The method of claim 1, wherein the partially converted stream has a lower viscosity at 50° C. than the stream of heavy oil.

12. The method of claim 1, wherein a T10 distillation point of the stream of heavy oil is at least about 900° F.

13. The method of claim 1, wherein the heavy oil has a Conradson carbon residue of between about 5 and about 50 wt %, as determined by ASTM D4530.

14. The method of claim 1, wherein the step of hydrocracking comprises slurry hydrocracking.

15. The method of claim 1, wherein the step of hydrocracking further comprises forming an unconverted slurry hydroconversion pitch.

16. The method of any claim 1, wherein the catalyst comprises at least one molecular sieve catalyst.

17. The method of any claim 1, wherein the catalyst comprises a molecular sieve selected from USY, ZSM-48, or a combination thereof.

18. The method of claim 1, wherein the heavy oil has a T5 boiling point of at least about 650° F.

19. The method of claim 1, wherein the stream of heavy oil is subjected to a pressure drop greater than 400 psig during hydrodynamic cavitation.

20. The method of claim 19, wherein the pressure drop is greater than 1000 psig.

21. The method of claim 20, wherein the pressure drop is greater than 2000 psig.

22. The method of claim 1, wherein the stream of heavy oil comprises a 1050° F. boiling fraction, and about 1 to about 50 wt % of the 1050+° F. boiling fraction is converted when subjected to hydrodynamic cavitation.

23. The method of claim 1, wherein the hydrodynamic cavitation is performed in the absence of a catalyst.

24. The method of claim 1, wherein the hydrodynamic cavitation is performed in the absence of a diluent oil or water.

25. The method of claim 1, further comprising upgrading a product of the hydrocracking by distillation, hydroprocessing, fluidized catalytic cracking, dewaxing, delayed coking, fluid coking, partial oxidation, gasification, deasphalting, or a combination thereof.

26. A method of upgrading a heavy oil comprising:
introducing a stream of heavy oil into a hydrodynamic cavitation unit;
cavitating a stream of heavy oil in the hydrodynamic cavitation unit under conditions to produce a partially converted stream;
introducing at least a part of the partially converted stream into a slurry hydrocracking reactor; and
converting the partially converted stream by slurry hydrocracking.

27. The method of claim 26, further comprising subjecting the partially converted stream to vapor-liquid separation to separate volatile components from the partially converted stream.

28. A system for upgrading a heavy oil comprising:
a heavy oil feed stream;
a hydrodynamic cavitation unit receiving the heavy oil feed stream and adapted to convert the heavy oil feedstream to a partially converted stream; and
a slurry hydrocracking unit downstream of the hydrodynamic cavitation unit and comprising a slurry reactor, wherein the slurry hydrocracking unit receives at least portion of the partially converted stream.

29. The system of claim 28, further comprising a vapor-liquid separator downstream of the hydrodynamic cavitation unit and upstream of the slurry hydrocracking unit, the vapor-liquid separator adapted to separate volatile components from the partially converted stream.
